(19) United States
(12) Patent Application Publication
(10) Pub. No.: US 2001/0037711 A1
(43) Pub. Date: Nov. 8, 2001

(54) Bread cutting machine provided with a safety device

(76) Inventor: Baudouin Van Cauwenberghe, Beersel (BE)

Correspondence Address: LAW OFFICE OF BARRY R LIPSITZ, 755 MAIN STREET, MONROE, CT, 06468, US

(21) Appl. No.: 09/865,491

(22) Filed: May 25, 2001

Related U.S. Application Data
(63) Continuation of application No. PCT/BE99/00124, filed on Sep. 28, 1999.

(51) Int. Cl. B26D 7/06

(52) U.S. Cl. 83/425.2; 83/932; 83/437.2

(57) ABSTRACT

A bread cutting machine provided with a safety device comprising mechanical linking means arranged between the adjacent edges of the entry and exit tables. The mechanical linking means has a first state when the two tables are in position and a second state when one of the tables is removed. When the mechanical linking means is in its second state, it acts on means actuating a position switch so as to prevent the machine from operating.

### FIELD OF THE INVENTION

The present invention relates to machines for cutting bread into slices, and it is concerned, in particular, with a safety device for manually controlled machines, that is to say machines into which the bread to be cut is pushed with the aid of a manual bread pusher.

### PRIOR ART

A bread cutting machine comprises essentially a frame, a cutting device with parallel multiple knives having an oscillating movement, a loading table, an unloading table and a bread pusher device for delivering the bread and holding it against the cutting device. A cowl covers the zone of the machine occupied by the cutting members.

Access to the internal zones of the machine, which are located below the bread entry and exit tables and below the machine cowl, is conventionally protected by the arrangement of the means for fastening the tables and the cowl to the body of the machine. In some machines, the fastening means in question are arranged in such a way that they require a tool for demounting. In this case, although safety in the use of the machine is ensured, the disadvantage of this type of fastening means is that they allow virtually no convenient access to the interior of the machine for cleaning purposes. In other machines, the fastening means in question are arranged so as to allow easy access to the interior of the machine in order to clean the members, but the user's safety must then be ensured by the provision of presence detectors, the function of which is to prevent the open machine from being started up. These detectors thus constitute additional control members which generally require the use of contactors.

It would be expedient and desirable if the internal zones of a bread cutting machine could be protected in such a way that demounting is easy, so as to allow access to the internal members of the machine, while at the same time guaranteeing the indispensable safety of the user when he is carrying out cleaning inside the machine. The object of the present invention is to propose a simple solution for achieving this aim.

### SUMMARY OF THE INVENTION

A first aspect of the invention is a safety device arranged around a mechanical connection means disposed between the bread entry and exit tables and cooperating with a position switch connected in such a way that, when it is actuated, it prevents the machine from being put into operation. This position switch is advantageously the main end-of-travel position switch of the machine. As soon as one or other of the tables in question is removed, the position switch is actuated and cuts off the supply so as thereby to prevent the machine from being started up.

A second aspect of the invention is that the cowl of the machine is made integral with the bread entry table. In this way, access to the internal members of the machine takes place easily and quickly simply as a result of the demounting of the tables of the machine.

The invention is explained in more detail below with the aid of the accompanying drawings.

### BRIEF DESCRIPTION OF THE DRAWINGS

FIG. 1 shows a sectional view of a bread cutting machine equipped with a safety device according to the invention.

FIG. 2 is a partial top view of the machine illustrated in FIG. 1.

FIG. 3 shows an enlarged view of the safety device shown in FIG. 1.

FIG. 4 shows an enlarged top view of the device shown in FIG. 2.

FIGS. 5 to 8 illustrate the functioning of the safety device as illustrated in FIGS. 3 and 4.

FIG. 9 shows the action of the support of the bread pusher on the end-of-travel position switch of the machine.

### DESCRIPTION OF AN EMBODIMENT

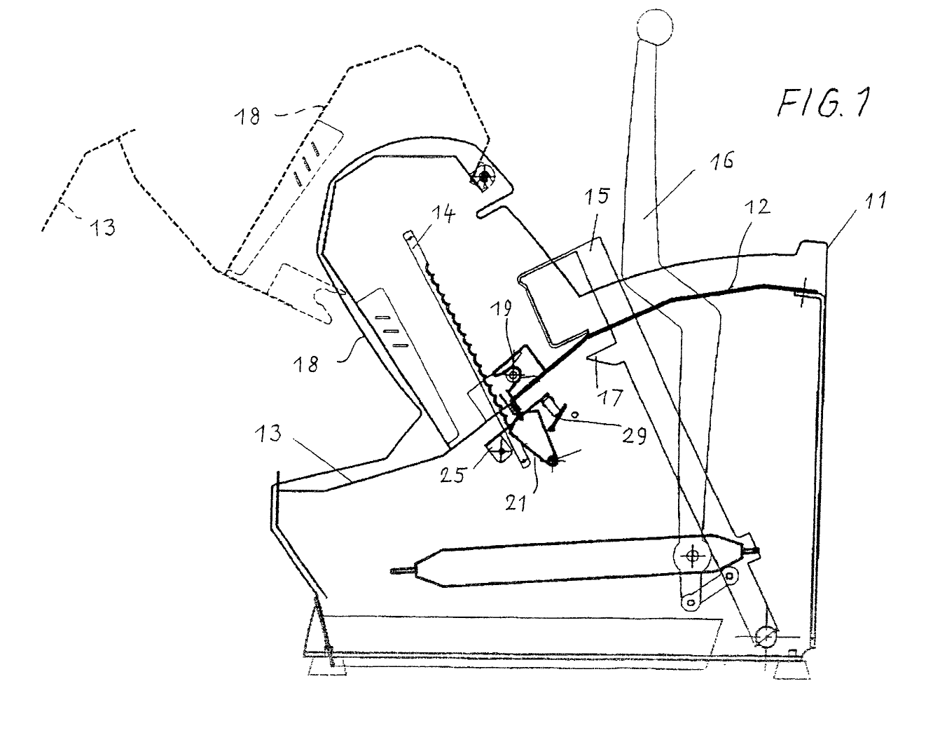

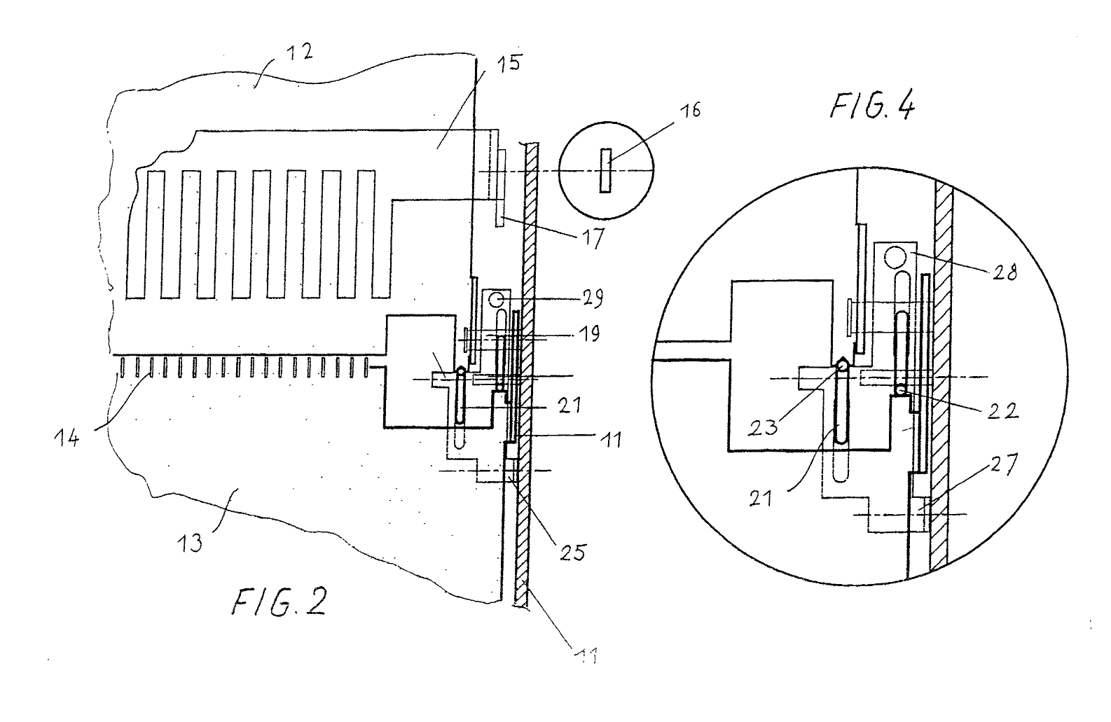

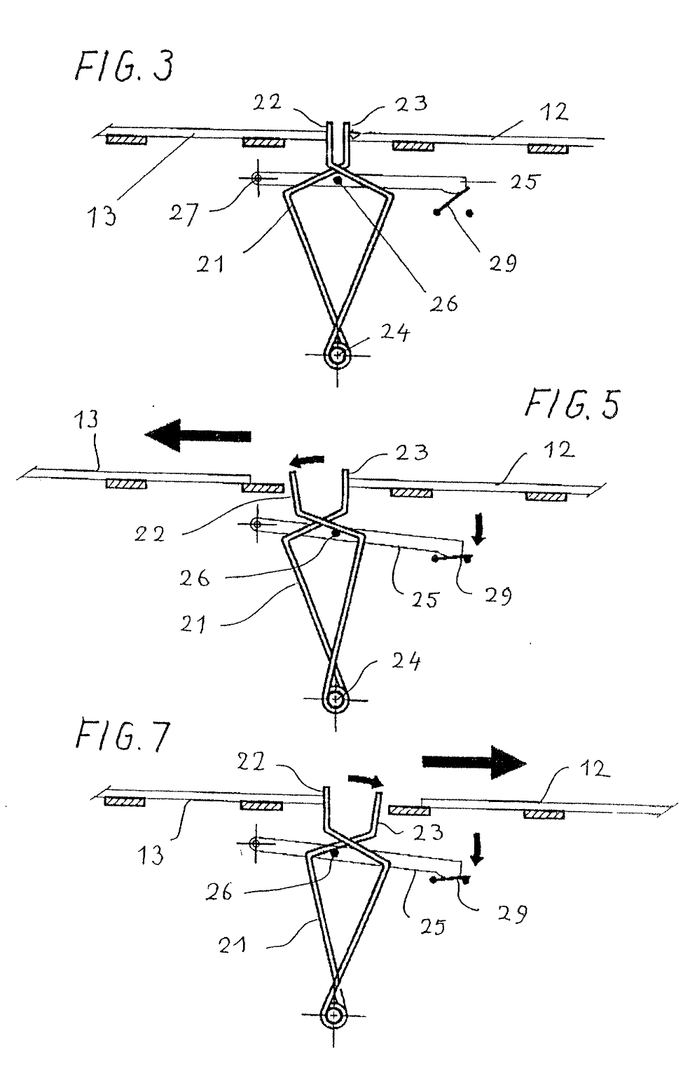

FIG. 1 illustrates an in no way limiting example of a bread cutting machine, of which can be seen the body 11, the bread loading or entry table 12, the bread unloading or exit table 13, a cutting device 14 and a bread pusher 15 with its control lever 16. According to the invention, between the bread entry table 12 and the bread exit table 13 is provided a safety device which is illustrated on a larger scale in FIGS. 3 and 4. This safety device comprises a mechanical connection means consisting, for example, of a clip 21, the two ends 22 and 23 of which are gripped between the adjacent edges of the tables 12 and 13. The clip 21 is mounted so as to be capable of pivoting about an axis 24 and cooperates with a lug 26 integral with an arm 25 which pivots about an axis 27 and the free end 28 of which cooperates with a position switch 29. This switch may be the main end-of-travel switch of the bread cutting machine.

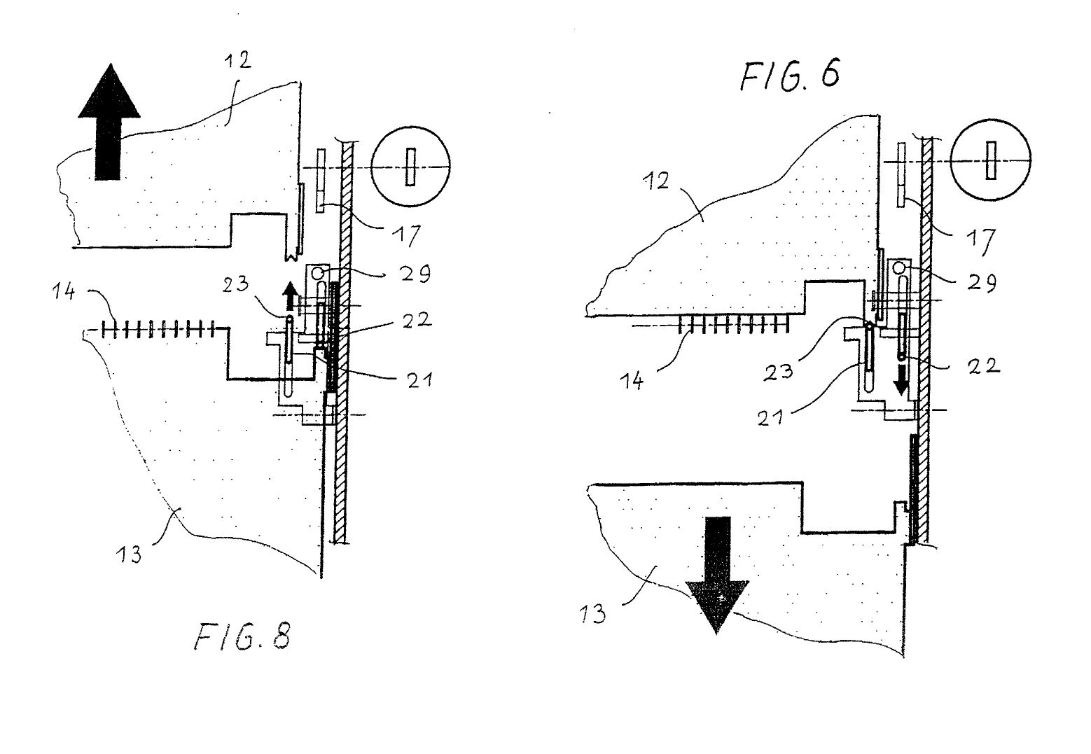

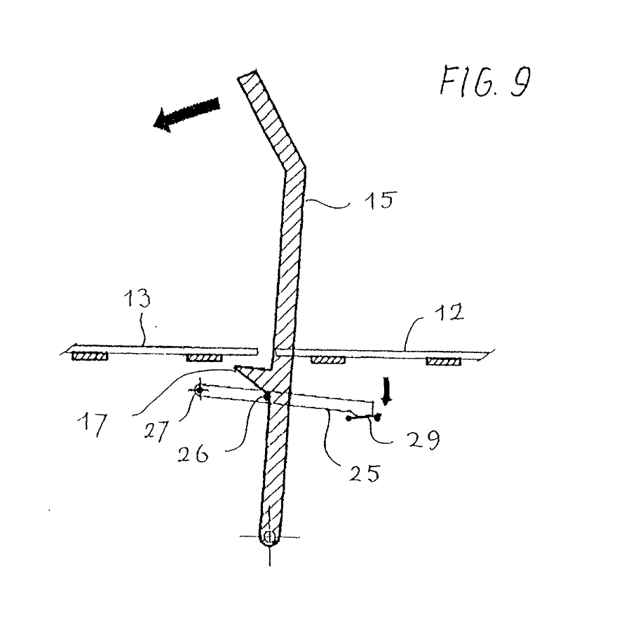

When, for example, the bread exit table 13 is removed, as illustrated in FIGS. 5 and 6, the end 22 of the clip 21 moves away from the end 23, thus causing the clip 21 to pivot about its axis 24 and exert downward pressure on the lug 26. The latter, in turn, causes the arm 25 to tilt, and the position switch 29 is actuated so as to prevent the machine from being started up. Access to the internal members of the machine below the bread exit zone can then take place without any risk to the user. The same safety procedure is carried out when the entry table 12 is removed, as illustrated in FIGS. 7 and 8.

In the example illustrated, the position switch 29 is the main end-of-travel switch of the bread cutting machine, said switch being actuated when the bread pusher 15 is brought to the end of its travel after a loaf of bread has been cut. As shown particularly in FIG. 8, the heel 17 provided on the support of the bread pusher acts on the lug 26 integral with the arm 25, said lug cooperating with the clip 21 of the safety device described above. It should be noted that the safety device according to the invention can be used with entry and exit tables which have any plane or curved profile.

Returning to FIG. 1, it can be seen that the machine advantageously comprises a cowl 18 which covers and protects the bread entry and exit zone. According to a second aspect of the invention, the cowl 18 is fastened to the bread exit table 13. The latter is itself engaged on stays 19 integral with the body 11 of the machine. The cowl/exit-table assembly can thus be mounted and demounted in one operation and therefore more quickly.

It goes without saying that the invention is in no way limited to the embodiment illustrated by way of example in the accompanying drawings. The safety device according to the invention may be produced in various equivalent embodiments within the normal competence of a person skilled in the art.

1. A bread cutting machine, comprising a bread entry table (12), a bread exit table (13), a cutting device (14) and a bread pusher device (15), characterized in that it comprises, furthermore, a safety device comprising a mechanical connection means (21) disposed between and against the adjacent edges of the entry (12) and exit (13) tables, said mechanical connection means being in a first state when the abovementioned two tables (12, 13) are in place and in a second state when one of said tables (12, 13) is removed, and means (25, 26) arranged so as to actuate a position switch (29) when said mechanical connection means (21) is in its second state, said switch serving for preventing the machine from being put into operation.

2. The bread cutting machine as claimed in claim 1, characterized in that said mechanical connection means (21) is shaped so as to cooperate with a lug (26) integral with an arm (25) arranged so as to act on the abovementioned position switch (29).

3. The bread cutting machine as claimed in either one of the preceding claims, characterized in that the abovementioned position switch (29) is the main end-of-travel switch of the machine.

4. The bread cutting machine as claimed in any one of the preceding claims, characterized in that the exit table (13) carries means for fastening an integral cowl (18).

6. A safety device for a bread cutting machine as defined in the preceding claims.
